(19) United States
(12) Patent Application Publication
(10) Pub. No.: US 2012/0235971 A1
(43) Pub. Date: Sep. 20, 2012

(54) DISPLAY DEVICE AND DISPLAY CONTROL METHOD OF DISPLAY DEVICE

(75) Inventor: TENG-FENG ZOU, Tu-Cheng (TW)

(73) Assignee: HON HAI PRECISION INDUSTRY CO., LTD., Tu-Cheng (TW)

(21) Appl. No.: 13/155,313

(22) Filed: Jun. 7, 2011

(30) Foreign Application Priority Data
Mar. 18, 2011 (TW) 100109270

(51) Int. Cl. G09G 3/36; G06F 3/038

(52) U.S. Cl. 345/211; 345/87

(57) ABSTRACT

A display device includes a display screen, at least one data interface, and a processor. The display screen is configured for showing images. The at least one data interface is configured for receiving image signal from a computer. The processor includes a processing unit, a first power source, and a second power source. The processing unit is configured for checking whether the data interfaces receive image signals and inputting the image signals into the display screen if the data interfaces receive image signals. The first power source is configured for supplying power to the processing unit continuously. The second power source is configured for supplying power to the display screen when the processing unit detects if the data interfaces receive image signals.

### BACKGROUND

1. Technical Field

The present disclosure relates to display technologies, and particularly, to a display device and a display control method of the display device.

2. Description of Related Art

Many computer include a separate display device, which is separately connected to a power source and so must be manually powered on when the computer is powered on. Because of this, users may forget to turn off the display device when they are done using the computer. This wastes electricity.

Therefore, it is desirable to provide a display device and a display control method of the display device, which can overcome or at least alleviate the limitations described.

### BRIEF DESCRIPTION OF THE DRAWINGS

FIG. 1 is a schematic view of a display device, according to a first exemplary embodiment.

FIG. 2 is a functional block of the display device of FIG. 1.

FIG. 3 is a flowchart of a display control method of the display device of FIG. 1, according to a second exemplary embodiment.

### DETAILED DESCRIPTION

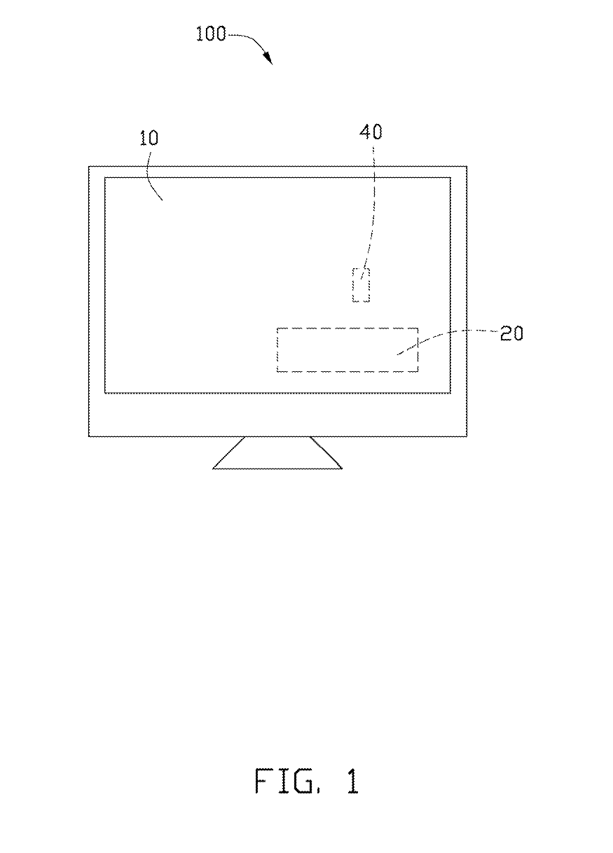

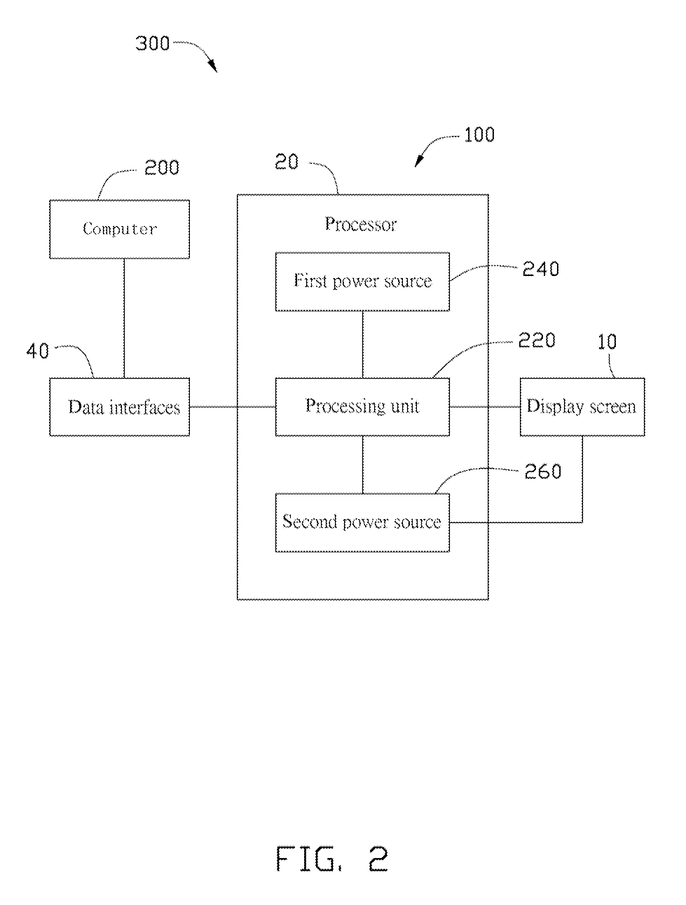

Referring to FIGS. 1-2, a display device 100, according to a first exemplary embodiment, includes a display screen 10, a processor 20, and data interfaces 40 inside the display screen 10. In this embodiment, the display device 100 is a part of a computer system 300. The computer system 300 includes a computer 200 electrically connected to the display device 100.

The display screen 10 is configured for displaying images. In this embodiment, the display screen 10 is a liquid crystal display (LCD) screen.

The data interfaces 40 includes a digital visual interface, a high definition multimedia interface, and a video graphic array interface. The data interfaces 40 are configured for receiving image signals output from the computer 200.

The processor 20 includes a processing unit 220, a first power source 240, and a second power source 260.

The first power source 240 is electrically connected to the processing unit 220. The first power source 240 is configured for continuously supplying power to the processing unit 220. In this embodiment, the first power source 240 is an internal battery of the display device 100.

The second power source 260 is electrically connected to the processing unit 220 and the display screen 10. The second power source 260 is configured for selectively supplying power to the display screen 10 in response to control of the processing unit 220.

The processing unit 220 is electrically connected to the data interfaces 40 and the display screen 10. The processing unit 220 is configured for checking whether the data interfaces 40 receive image signals or not. If the data interfaces 40 receive image signals, the processing unit 220 controls the second power source 260 to supply power to the display screen 10 and input the image signals to the display screen 10, thereby showing images on the display screen 10. If the data interfaces 40 do not receive image signals, the processing unit 220 cuts the second power source 260 off, thereby the display screen 10 is turned off.

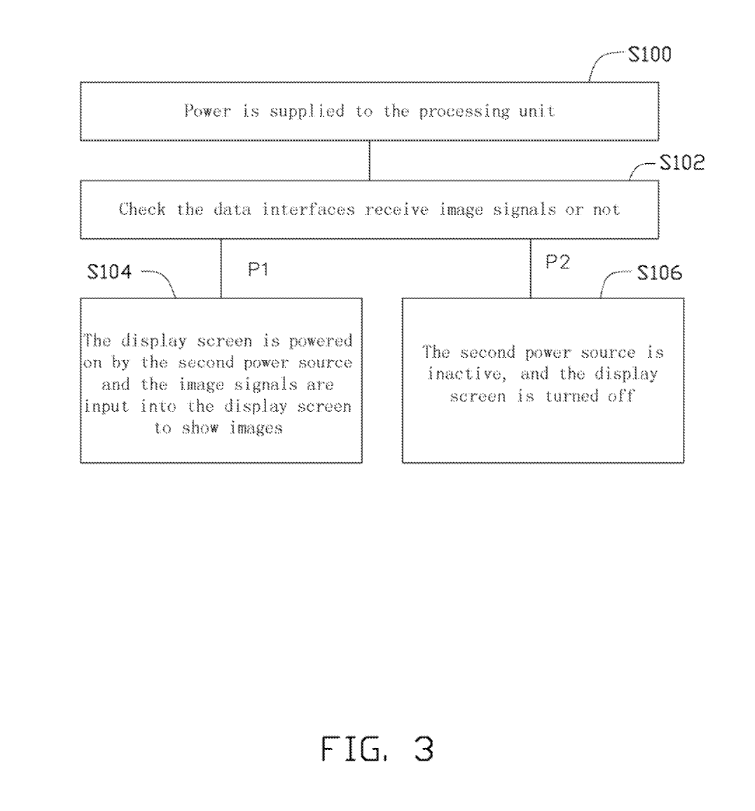

Referring to FIG. 3, a display control method can be implemented by, for example, the display device 100 and includes steps S100 through S110. In Step S100 power is supplied to the processing unit 220. In particular, the first power source 240 continuously supplies power to the processing unit 220. In Step S102 check if the data interfaces 40 receive image signals or not. If the data interfaces 40 receive the image signals, the method follows path P1 to implement Step S104, in which the display screen 10 is powered on by the second power source 260 and the image signals are input into the display screen 10 to show images. If the data interfaces 40 do not receive the image signals, the method follows path P2 to implement Step S106, in which the second power source 260 is inactive, and the display screen 10 is turned off. During the display control method, when the computer 200 is powered on, the data interfaces 40 receive the image signals; the display device 100 is automatically powered on. When the computer 200 is powered off, the data interfaces 40 do not receive any image signals, the display device 100 is automatically powered off to save energy. This is convenient and saves energy.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A display device, comprising:
a display screen configured for showing images;
at least one data interface configured for receiving image signals from a computer; and
a processor comprising:
a processing unit configured for checking if the data interfaces receive image signals and inputting the image signals into the display screen if the data interfaces receive image signals;
a first power source configured for continuously supplying power to the processing unit; and
a second power source configured for supplying power to the display screen when the processing unit checks if the data interfaces receive image signals.

2. The display device as claimed in claim 1, wherein the display screen is a liquid crystal display screen.

3. The display device as claimed in claim 1, wherein the first power source is a battery.

4. The display device as claimed in claim 1, wherein the at least one data interface is selected from a digital visual interface, a high definition multimedia interface, and a video graphic array interface.

5. A display control method for a display device comprising a display screen, at least one data interface, and a processor having a first power source, a processing unit, and a second power source, the method comprising:
supplying power to the processing unit continuously;
checking if the at least one data interface receives an image signal or not;
wherein, if the at least one data interface receives an image signal, powering the display screen on via the second power source and the inputting image signal into the display screen to show an image;
if the at least one data interface does not receive an image signal, powering the display screen off as the second power source is inactive.

6. A computer system, comprising:
a computer; and
a display device electrically connected to the computer, comprising:
a display screen configured for showing images;
at least one data interface configured for receiving image signals from the computer; and
a processor comprising:
a processing unit configured for checking if the data interfaces receive image signals and inputting the image signals into the display screen if the data interfaces receive image signals;
a first power source configured for continuously supplying power to the processing unit; and
a second power source configured for supplying power to the display screen when the processing unit checks if the data interfaces receive image signals.

7. The computer system as claimed in claim 6, wherein the display screen is a liquid crystal display screen.

8. The computer system as claimed in claim 6, wherein the first power source is a battery.

9. The computer system as claimed in claim 6, wherein the at least one data interface is selected from a digital visual interface, a high definition multimedia interface, and a video graphic array interface.
